(19) United States
(12) Patent Application Publication
(10) Pub. No.: US 2007/0208447 A1
(43) Pub. Date: Sep. 6, 2007

(54) Direct manufactured fillets for composite structures

(76) Inventor: Kevin T. Ostrega, St. Peters, MO (US)

Correspondence Address: OSTRAGER CHONG FLAHERTY & BROITMAN, P.C., 570 LEXINGTON AVENUE, FLOOR 17, NEW YORK, NY, 10022-6894, US

(21) Appl. No.: 11/366,313

(22) Filed: Mar. 2, 2006

(51) Int. Cl. G06F 19/00

(52) U.S. Cl. 700/118; 700/117

(57) ABSTRACT

A method of manufacturing a composite structure comprises laying up a multi-surface structure comprised of at least one surface joint forming a radial gap. A fillet element is direct manufactured having a fillet cross-section configured to match the radial gap. The fillet element is inserted into the radial gap and cured along with the multi-surface composite structure.

### TECHNICAL FIELD

The present invention relates generally to a method of generating fillets for composite structures, and, more particularly to a method utilizing direct manufacturing for the generation of custom fillets.

### BACKGROUND OF THE INVENTION

Composite structures are highly prized for their ability to combine high strength and design flexibility with resultant reduced weight structures. As such, in many fields they dominate the manufacturing landscape. Despite their popularity, or perhaps as a result of it, composite lay-up structures have generated a host of new manufacturing challenges. These challenges often stem from attempts to apply the composite design methodologies to complex structures. Laying up epoxy impregnated sheets into complex structures forces manufacturers to address the physical nature of impregnated fiber sheets and to develop methods for laying them, retaining them, and curing them into these complex shapes.

One area of particular complexity arises in the manufacture of multi-surface structures. When fiber sheets are laid up into multiple surfaces, they form surface joints where a first surface transitions into a second. At these transition points, the plies by their nature form radius instead of hard chine corners. As a result, wherein separate lay-ups come together at these radius corners, a radial gap is commonly formed. These radial gaps can generate ply distortion at the surface joints which in turn may result in reduced strength of the multi-surface structures.

At present, the approach to reducing the negative impact of radial gaps in these composite lay-up structures has been to insert wound fillets into the gaps prior to subsequent lay-up and curing. The utilized wound fillets commonly represent very rough approximations of the radial gaps and therefore provide installation difficulties as well as a reduction in performance. Considerable manufacturing time may be expended to provide even a somewhat reasonable fit within the radial gap. Even then, however, the gaps may only remain partially filled and some level of ply distortion may still exist.

It would, therefore, be highly desirable to have a method for producing fillets that provides fillets with cross-sections specifically tailored to individual radial gaps such that a much improved multi-surface composite structure was produced. Similarly, it would be highly desirable to have a method for producing such improved fillets that reduced the time intensive manufacturing procedures presently utilized for fillet production.

### SUMMARY OF THE INVENTION

A method of manufacturing a composite structure is provided comprising laying up a multi-surface structure comprised of at least one surface joint forming a radial gap. A fillet element is direct manufactured having a fillet cross-section configured to match the radial gap. The fillet element is inserted into the radial gap and cured along with the multi-surface composite structure.

Other features of the present invention will become apparent when viewed in light of the detailed description of the preferred embodiment when taken in conjunction with the attached drawings and appended claims.

### BRIEF DESCRIPTION OF THE DRAWINGS

FIG. 1 is an illustration of a generic direct manufacturing system for use in the present invention;

FIG. 2 is an illustration of a fillet element generated by the direct manufacturing system illustrated in FIG. 1, the fillet having a universal fillet cross-section;

FIG. 3 is an illustration of a fillet element generated by the direct manufacturing system illustrated in FIG. 1, the fillet element having a varied fillet cross-section;

FIG. 4 is an illustration of multi-surface composite structures for use with the fillet element generated in FIG. 2;

FIG. 5A is an illustration the multi-surface composite structures illustrated in FIG. 3, the structures illustrated with the fillet element installed and a cover surface laid-up;

FIG. 5B is an illustration of an additional embodiment of the multi-surface composite structure, the embodiment illustrating a t-structure; and

FIG. 5C. is an illustration of an additional embodiment of the multi-surface composite structure, the embodiment illustrating an angle-structure.

### DESCRIPTION OF THE PREFERRED EMBODIMENT(S)

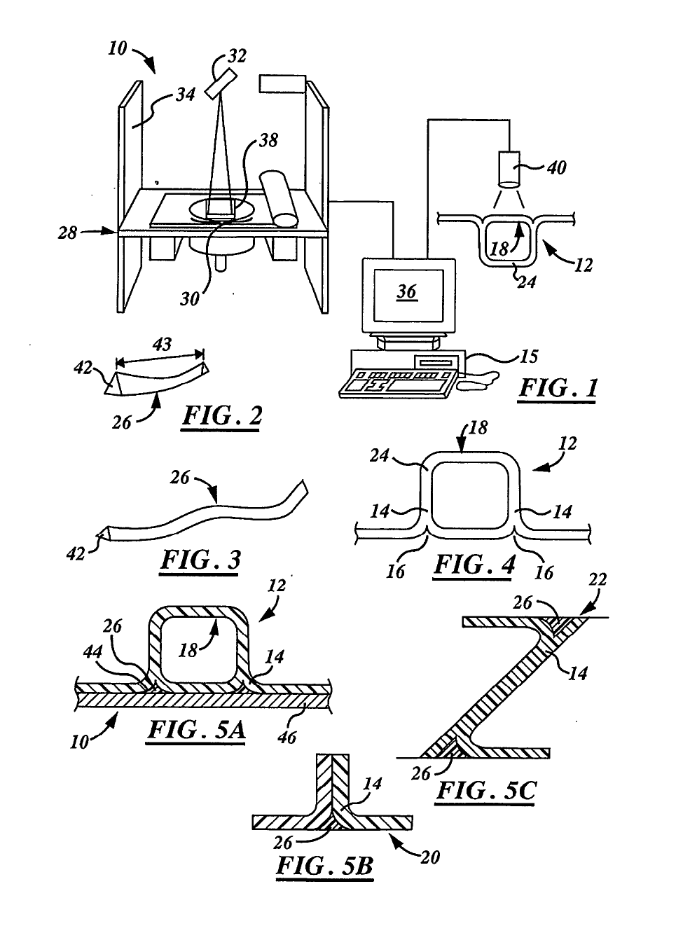

Referring now to FIG. 1, which is an illustration of a method of manufacturing a composite structure 10 in accordance with the present invention. The method 10 includes laying-up a multi-surface structure 12 having at least one surface joint 14 forming a radial gap 16. The multi-surface structure 12 illustrated in FIG. 1, is a hat-structure 18, however a wide variety of such structures are contemplated including, but not limited to, the t-structure 20 and angle-structures 22 illustrated in FIGS. 5B and C respectively. The concern in composite structures such as the multi-surface structure 12 is that the radial gap 16 may result in distortion of the plies 24 prior to curing and/or may weaken the resultant cured structure.

The present invention addresses this concern by utilizing a method to direct manufacture a fillet element 26 specifically tailored to a given radial gap 16. This is accomplished through the use of a direct manufacturing assembly 28. It is contemplated that the direct manufacturing assembly 28 illustrated is for instructional purposes only and includes, but is not limited to, selective laser sintering, stereo lithography, fused deposition modeling, laminate object manufacturing, and electron beam melting. The majority of these techniques utilize a bath chamber 30 and laser assembly 32 positioned within a chamber 34 connected to a modeling computer 36 wherein a CAD or similar design is translated into a direct physical object 38 within the chamber 34. The present invention contemplates that the modeling computer 36 may be utilized to model both the lay-up of the multi-surface structure 12 and the resultant radial gap 16. Alternately, after lay-up of the multi-surface structure 12, a vision system 40 may physically analyze the specific radial gap 16 of the multi-surface structure 12 and send this information to the modeling computer 36 for modeling.

The direct manufacturing assembly 28 is utilized to form a flexible fillet element 26 (also referred to as noodles or nuggets) having a fillet cross-section 42 specifically adapted to a given radial gap 16 application. This includes applications wherein a universal or constant fillet cross-section 42 is desirable (FIG. 2). This also includes producing a varied fillet cross-section 42 as shown in FIG. 3 wherein the cross-section varies over the fillet length 43. The production of varied fillet cross-sections 42 is highly beneficial since it may be designed to match subtle variations in the radial gap 16 throughout the multi-surface structure 12 and thereby provide a more accurate fill.

The fillet element 26 is preferably produced from a material bondable to the multi-surface structure 12 during curing. It is contemplated, however, that the fillet element 26 may be retained with adhesive 44 if such a bondable composition is not readily available. In either case the fillet element 26 is positioned within the radial gap 16 as shown in FIGS. 5A-C to substantially fill the radial gap 16. A cover structure 46 may be laid up on top of the fillet element 26 prior to curing such that the resultant cured composite structure 10 contains no radial gaps 16. This provides a quick and tailored approach to composite lay-up mechanics not seen in the industry. The resultant composite structure is structurally improved and quicker to produce.

While particular embodiments of the invention have been shown and described, numerous variations and alternative embodiments will occur to those skilled in the art. Accordingly, it is intended that the invention be limited only in terms of the appended claims.

What is claimed is:

1. A method of manufacturing a composite structure comprising:
laying up a multi-surface structure, said multi-surface structure comprising at least one surface joint forming a radial gap;
direct manufacturing a fillet element having a fillet cross-section configured to match said radial gap;
inserting said fillet element into said radial gap; and
curing said multi-surface structure and said fillet to form the composite structure.

2. A method as described in claim 1, further comprising:
laying up a cover surface over said fillet element prior to said curing.

3. A method as described in claim 1, wherein said multi-surface structure comprises a structure selected from the group consisting of a hat structure, a t-structure and an angle structure.

4. A method as described in claim 1, wherein said fillet cross-section comprises a universal fillet cross-section.

5. A method as described in claim 1, wherein said fillet cross-section comprises a varied fillet cross-section configured to compliment a varied radial gap.

6. A method as described in claim 1, further comprising:
modeling said fillet cross-section utilizing a computer modeling system.

7. A method as described in claim 1, further comprising:
utilizing a visualization system to develop a model of said fillet cross-section;
sending said model to a direct manufacturing assembly.

8. A method as described in claim 1, wherein said direct manufacturing comprises:
utilizing one of selective laser sintering, stereo lithography, fused deposition modeling, laminate object manufacturing, or electron beam melting.

9. A method as described in claim 1, wherein said fillet element comprises a flexible fillet element.

10. A method as described in claim 1, further comprising:
direct manufacturing said fillet element out of a fillet material bondable to said multi-surface structure.

11. A method as described in claim 1, further comprising:
applying an adhesive to said fillet element prior to insertion into said radial gap.

12. A method of manufacturing a composite structure comprising:
laying up a multi-surface structure, said multi-surface structure comprising at least one surface joint forming a radial gap;
direct manufacturing a fillet element having a fillet cross-section configured to match said radial gap, said fillet element manufactured from a flexible material bondable to said multi-surface structure; and
inserting said fillet element into said radial gap; and
curing said multi-surface structure and said fillet to form the composite structure.

13. A method as described in claim 12, further comprising:
modeling said fillet cross-section utilizing a computer modeling system

14. A method as described in claim 12, further comprising:
utilizing a visualization system to develop a model of said fillet cross-section;
sending said model to a direct manufacturing assembly.

15. A method as described in claim 12, wherein said direct manufacturing comprises:
utilizing one of selective laser sintering, stereo lithography, fused deposition modeling, laminate object manufacturing, or electron beam melting.

16. A method as described in claim 12, further comprising:
laying up a cover surface over said fillet element prior to said curing.

17. A composite structure comprising:
a pre-cured multi-surface structure comprising at least one surface joint forming a radial gap; and
a direct manufactured fillet element having a fillet cross-section configured to substantially match said radial gap, said fillet element inserted into and bonded to said radial gap;
said procured multi-surface structure cured to form said composite structure.

18. A composite structure as described in claim 17, further comprising:
a pre-cured cover surface laid up over said fillet element prior to curing said multi-surface structure.

19. A composite structure as described in claim 17, wherein said multi-surface structure comprises a structure selected from the group consisting of a hat structure, a t-structure, and an angle structure.

20. A composite as described in claim 17, wherein said fillet cross-section comprises a universal fillet cross-section.

21. A composite as described in claim 17, wherein said fillet cross-section comprises a varied fillet cross-section.

22. A composite as described in claim 17, wherein said fillet element comprises a flexible fillet element bondable to said multi-surface structure.
